(19) United States
(12) Patent Application Publication
(10) Pub. No.: US 2021/0211757 A1
(43) Pub. Date: Jul. 8, 2021

(54) SYSTEMS AND METHODS FOR ADAPTING PLAYBACK DEVICE FOR CONTENT DISPLAY

(71) Applicant: SOURCEPICTURE INC., New York, NY (US)

(72) Inventors: Seth Haberman, New York, NY (US); Andrew Setos, Pacific Palisades, CA (US)

(73) Assignee: SOURCEPICTURE INC., New York, NY (US)

(21) Appl. No.: 17/142,884

(22) Filed: Jan. 6, 2021

Related U.S. Application Data
(60) Provisional application No. 62/957,545, filed on Jan. 6, 2020.
(60) Provisional application No. 62/957,552, filed on Jan. 6, 2020.

(51) Int. Cl. H04N 21/258; H04N 21/235; H04N 21/422; H04N 21/431; H04N 21/239; H04N 21/2387

(52) U.S. Cl. CPC H04N 21/25825; H04N 21/235; H04N 21/2387; H04N 21/431; H04N 21/2393; H04N 21/42202

(57) ABSTRACT

Aspects of the present disclosure include systems and methods for adapting presentation settings for playback of content, including adapting the display settings of a presentation device based on the content, an ambient condition, such as ambient light, as detected by an environmental sensor in or coupled to the display device, and exogenous data. Configuration profiles may be generated including exogenous data relating to the capture and production of the content. The configuration profiles may include provider presentation settings and presentation instructions for a presentation device that when applied, enhance the presentation of the content on the display to appear as the content creator intended.

### CROSS-REFERENCE TO RELATED APPLICATIONS

This application claims the benefit of U.S. Provisional Application No. 62/957,545, filed on Jan. 6, 2020 and U.S. Provisional Application No. 62/957,552, filed on Jan. 6, 2020, the contents of which are incorporated by reference in their entirety as if fully set forth herein.

### FIELD OF TECHNOLOGY

The present disclosure is directed towards the presentation of content, more specifically, the enhanced visual display of digital content using environmental and/or exogenous data to adapt a presentation device display.

### BACKGROUND

Digital display and audio technology has rapidly and remarkably improved the viewing experience of television and digital content consumers. Television manufacturers today provide myriad visual and audio settings, special effects and other personalization capabilities for a viewer to customize their own experience when watching broadcast programming. Those manufacturers have also developed many different, sometimes proprietary technologies for presenting that content, such as OLED, QLED, zoned backlight LCD, MicroLED, plasma. For example, most digital televisions available in the market include pre-defined modes in which several display settings (contrast, brightness, edge detection, dynamic color range, bass, treble, etc.) are customized for a particular viewing experience, such as “sports,” “movies,” “vivid,” “game mode.” Such preset modes, when selected, apply a distinct configuration of the display's settings to enhance certain features that the designer of the TV product thinks is important to the type of content being viewed.

A viewer may, depending on the content he or she is watching, choose the preset mode through a sequence of menu browsing and selection of the desired setting mode. Often, however, the viewer fails to take advantage of these nominal features either because he has forgotten their availability, or it is too time consuming, confusing, or the settings are inconsistent with the programs being viewed (e.g., a viewer switching between a sporting event and a movie, or a movie that is darker than another movie). For a viewer to properly take advantage of these display modes, the viewer would need to go through the tedious menu browsing and selection of the appropriate mode every time the viewer changed channels, changed content inputs or selected a new program to watch. This inconvenience typically causes viewers to keep their display settings in the same configuration no matter the chosen input or program and fails to provide the enhanced viewing experience for which the display is capable of presenting.

Importantly, preset display settings are not “one size fits all,” in that even within a genre of programming, such as “sports” or “movies,” each particular piece of content is unique and may not be best viewed using pre-defined generalized display settings. For example, the “sport” setting might have been designed for daytime sports but the viewer is watching a sporting event taking place at night, rendering the setting less than optimal. Or a golf match filmed outdoors in sunny conditions with a substantially dark background (green grass) may be better viewed using substantially different display settings than an indoor hockey game (substantially white background).

Further, the different number of viewing devices available to a consumer also provides another hindrance in fully optimizing the presentation settings of media content. With the proliferation of television-ready personal computers, internet content providers, and sophisticated smart-phones and tablet devices, the number and presentation capabilities of viewing devices further complicates the ability to optimally enhance the presentation of the media content. For example, a 52-inch, LED television set may provide a vastly different viewing experience that that of a smartphone device or a 77″ OLED or a 65″ LCD television. The audio and visual capabilities of each device and the networks over which the content may be transmitted differ greatly, such that a user may experience very different viewing experiences depending on which device the content is consumed.

### SUMMARY

Aspects of the present disclosure include systems and methods for adapting presentation settings for playback of content, including adapting the display settings of a presentation device based on the content, an ambient condition, such as ambient light, as detected by an environmental sensor in or coupled to the display device, and exogenous data. Configuration profiles may be generated including exogenous data relating to the capture and production of the content. The configuration profiles may include provider presentation settings and presentation instructions for a presentation device that when applied, enhance the presentation of the content on the display to appear as the content creator intended.

According to one aspect, a method for adapting the presentation of content on a presentation device is disclosed. presentation device information and a request for a configuration profile associated with a content asset may be received from the presentation device. Provider presentation settings may be retrieved according to the presentation device information and the content asset. A configuration profile may be generated including the provider presentation settings and presentation instructions. The configuration profile may be transmitted to the presentation device.

According to another aspect, a method for adapting the presentation of content on a presentation device is disclosed. Presentation device information and a request for a configuration profile associated with a content asset may be received from the presentation device. Environmental data may be received from the presentation display device. exogenous data may be retrieved according to the content asset. Provider presentation settings may be retrieved according to the presentation device information, the environmental data, exogenous data and the content asset. A configuration profile may be generated including the provider presentation settings, exogenous data, and presentation instructions. The configuration profile may be transmitted to the presentation device.

According to another aspect of the present disclosure, a system for adapting the presentation of content on a presentation device is disclosed. A database may store presentation device information and provider presentation settings. The system may include a communications interface and a processor configured to receive from the presentation device via the communications interface presentation device information and a request for a configuration file associated with a content asset. Provider presentation settings may be retrieved from the database corresponding to the presentation device information and the content asset. A configuration profile may be generated including the provider presentation settings and presentation instructions. The configuration profile may be transmitted via the communications interface to the presentation device.

According to another aspect of the disclosure, a method for adapting the presentation of content on a presentation device is disclosed. A content asset may be requested. Presentation device information and a content identifier to the service provider may be transmitted. A configuration profile including provider presentation settings and presentation instructions may be received. The provider presentation settings and instructions may be based on the presentation device information and the content identifier. The presentation instructions may be executed to adapt one or more display settings according to the provider presentation settings.

According to another aspect, a system for adapting the presentation of content may include a presentation device, one or more environmental sensors in communication with the presentation device; a configuration manager in communication with the presentation device the and the one or more environmental sensors; and a processor in communication with the presentation device, the one or more environmental sensors and the configuration manager. The processor may be configured to request a content asset; receive a request for presentation device information from a service provider; transmit presentation device information to the service provider; receive a configuration profile including provider presentation settings and presentation instructions, the provider presentation settings adapted according to the presentation device information; and decode the configuration profile to adapt one or more display settings of the presentation device according to the provider presentation settings and presentation instructions.

According to another aspect, a method for adapting the presentation of content on a presentation device may include requesting a content asset; obtaining environmental data from a sensor coupled to the presentation device; transmitting presentation device information, the environmental data, and a content identifier to the service provider; receiving a configuration profile including provider presentation settings and presentation instructions, the provider presentation settings and instructions based on the presentation device information, environmental data, exogenous and the content identifier; and executing the presentation instructions to adapt one or more display settings according to the provider presentation settings.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 depicts a content presentation network according to Some embodiments.

FIG. 2 depicts presentation settings for an illustrative content presentation device according to some embodiments.

FIG. 3 depicts an illustrative content delivery configuration providing presentation settings.

FIG. 4 depicts an illustrative content presentation device according to Some embodiments.

FIG. 5 depicts a programming guide for providing presentation settings according to Some embodiments.

FIG. 6 depicts a presentation settings request interface for video content according to Some embodiments.

FIG. 7 depicts a conceptual presentation environment according to one aspect of the present disclosure.

FIG. 8 depicts a content capture system according to one aspect of the present disclosure.

FIG. 9 depicts a diagram illustrating an example of a hardware implementation for a display adaptation system according to one aspect of the present disclosure.

FIG. 10 depicts an illustrative method of adapting presentation content according to one aspect of the present disclosure.

FIG. 11 depicts an illustrative method of adapting presentation content according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. It will be apparent to those skilled in the art, however, that these concepts may be practiced without these specific details. In some instances, well-known structures and components are shown in block diagram form in order to avoid obscuring such concepts.

The described technology generally relates to systems and methods for managing presentation settings associated with presenting content through a presentation device. Content (or a “content asset”) may generally include any type of data, information, media, or the like that may be expressed through a medium. Illustrative mediums may include audio and visual mediums such as television, radio, and broadcast, cable, satellite, US ATSC1.0, ATSC3.0, UHF broadcast, streaming, fixed media (DVD, Blueray, digital download), mobile, local networked server, IP sources tied to subscription Internet access, public wi-fi, advanced communication networks, 5G, microwave, millimeter wave, satellite C, KU, Ka and/or network (e.g., Internet) forms thereof. Examples of content may include, but are not limited to, video, audio, movies, video games, television and radio programs, commercials, websites, images, photographs, text, electronic or digital documents, haptic or tactile sensations, information feeds, streaming media, and/or combinations thereof. Content may include pre-recorded content or live-action content transmitted in real-time to the presentation device.

A presentation device may be generally any device now known to those having ordinary skill in the art or developed in the future that is capable of presenting content on a display to a viewer or other type of content consumer. The display may be integral to the presentation device or may be a separate, but communicatively coupled, device. Non-limiting examples of presentation devices include televisions, smart televisions, laptops, personal digital assistants (PDAs), projectors, smartboards, electronic billboards, digital signage, table computing devices, smartphones, personal computers (PCs), gaming consoles, display monitors or terminals, radios, audio devices, speakers, headphones, haptic devices, electronic reading devices (“e-readers”), light emitting diode (LED) devices, organic LED (OLED) devices, wearable screens, set-top-boxes, satellite receivers, video-on-demand (VOD) receivers, streaming receivers, digital video recorders (DVRs), personal video recorders (PVRs), hard drives, flash drives, storage servers, digital video disc (DVD) devices, Blu-ray devices, or the like.

A presentation setting generally includes any type of sensory setting or mode capable of configuring how a presentation device presents content, including without limitation, audio, visual, tactile, or other sensory characteristic. For instance, a television may have presentation settings for configuring the brightness and contrast of the display presenting the content. In another instance, an audio device may have presentation settings for configuring the bass and treble of sound emitted by the audio device. In some aspects, the presentation settings may be converted, formatted, structured, translated, or otherwise arranged into presentation instructions configured to program, instruct, control, or otherwise manage the presentation settings of a presentation device. For example, presentation instructions may be configured to instruct the operating system, software, and/or hardware of a presentation device to change the presentation settings to those specified in the presentation instructions.

In some aspects, the content may be associated with one or more presentation settings. In some aspects, the content may be associated with enhanced and/or optimized presentation settings configured for the content and/or a presentation device. In some aspects, the presentation settings may be delivered and/or made otherwise accessible to the presentation device in association with the content. For instance, the presentation settings may be transmitted (e.g., in the form of presentation instructions) along with the content or may be provided by an input device or interface, such as USB, HDMI, Thunderbolt, Wi-Fi, Ethernet, Optical, Bluetooth, SD card, near-field communication (NFC), radio frequency (RF), or the like. Additionally, provider presentation settings may be provided via an outboard connect device via those inputs, such as set-top-boxes, USB sticks, OTT devices, networked servers, DVD, CD, Blu-ray, or the like. In another instance, the presentation settings may be accessible along with the content, such as through an interface for selecting content, including, without limitation, a program guide, an electronic program guide, an electronic program guide application or mobile computing device application (“mobile app” or “app”), and/or combinations thereof. For example, data transmitted to a receiver device detailing program information may also include data for which the viewer's display device may recognize, read and configure the display settings once the viewer selects the program to be viewed.

As used herein, “provider presentation settings” generally may refer to presentation settings for a content asset configured externally for a presentation device. For instance, provider presentation settings may be pre-calculated and configured by a content creator, service provider, device manufacturer, third party, external software application, etc. before or during transmission of content to a presentation device according to an optimal or desired presentation of the content. As used herein, “presentation settings” may generally refer to the display settings as configured on an actual presentation device. Table I, below, lists exemplary presentation settings of a presentation device

TABLE I
Exemplary Presentation Settings

| | | |
|---|---|---|
| Contrast | AI Picture | Gamma |
| Brightness | Dynamic Contrast | White Balance |
| Color | Dynamic Tone Mapping | Color Management |
| | | System |
| Tint | Dynamic Color | Peak Brightness |
| Sharpness | Preferred Color | Smooth Gradation |
| Color Temperature | Color Gamut | Black Level |
| Control Backlight | Super Resolution | LED Local Dimming |

While Table I reflects exemplary visual presentation settings, one skilled in the art will recognize that presentation settings may be device-specific and presentation devices made by different manufacturers may include additional or fewer settings and/or settings with different names or variations. Additionally, while Table I reflects exemplary visual presentation settings, presentation devices may also include audio presentation settings, including without limitation, bass, treble, balance, loudness, or the like.

In some aspects, a transport stream, or other delivery interface, transmitting a piece of content may include a portion which defines the optimal presentation settings for the content. The presentation device may include appropriate circuitry or other software and/or hardware, as described herein, to recognize and read the presentation setting portion (e.g., the presentation instructions) and to automatically and dynamically configure the presentation device according to those settings.

According to another aspect, the presentation settings may be obtained in separate transmissions apart from the content itself. As described herein, when a viewer selects a content asset for playback, or live presentation, a request for presentation settings may be requested by the presentation device. Appropriate presentation settings may be transmitted to the presentation device from a content provider, service provider or other party, to which the presentation device may adapt its presentation settings for displaying the current content asset.

In some aspects, a viewer or other content consumer may directly retrieve or “look-up” the presentation settings, for example, via a broadcast network or other network, such as the Internet. In such an aspect, the viewer may initiate a request for the display, or associated receiver device, to poll a server, database, or other network component for the presentation settings. In some aspects, combinations of select content and different device types may be pre-cached in the network or locally. The server or other device may transmit the settings to the presentation device, a receiver device or other device capable or recognizing and configuring the presentation settings of the display.

In some aspects, enhanced viewing capabilities as described herein may be offered as a premium service to subscribers or consumers who opt to pay an additional fee to provide the enhanced systems provided in this description.

Although certain examples and aspects described herein may detail the use of broadcast cable or satellite transmissions, one skilled in the art would recognize that other delivery interfaces may be used, including, without limitation, the Internet, closed circuit networks, local and wide area networks, or fixed media such as optical media, thumb drives, or a combination thereof without deviating from the scope of the aspects described herein.

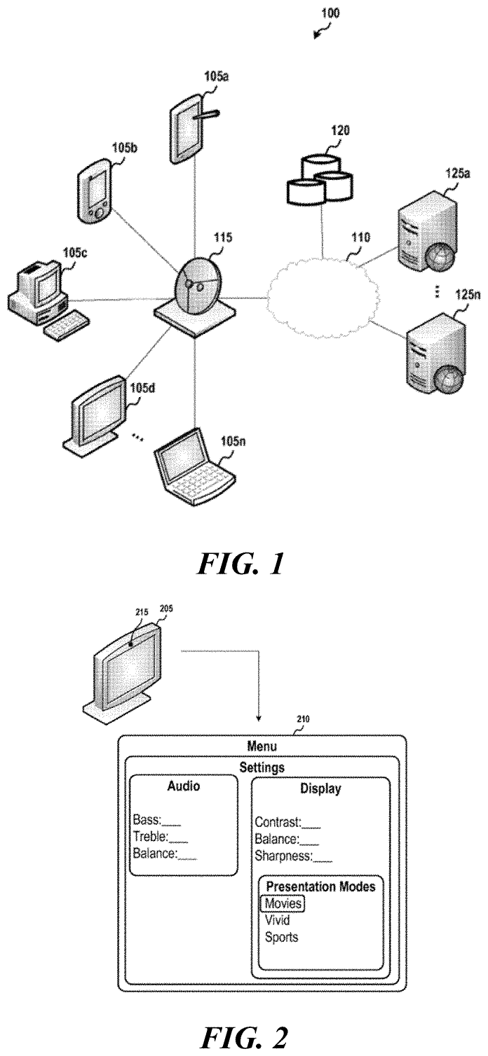

FIG. 1 depicts a content presentation network according to some aspects. As shown in FIG. 1, a display adaptation system 100 may include content providers 125a-n configured to provide content to a service provider 115. A content provider 125a-n may include any type of content provider or creator known to those having ordinary skill in the art, such as a television\movie studio or broadcast network, a radio channel, a website provider, podcast provider, a VOD service, an Over-the-Top (OTT) service, a content storage and delivery service, or the like. A service provider 115 may access content from the content providers 125a-n over a network, such as a cable or satellite network or a communications network, such as the Internet. The service provider 115 may include any type entity or structure capable of providing content to a presentation device 105a-n. For instance, the service provider 115 may include a television broadcast network, a cable television network, a satellite television network, an internet service provider (ISP), a website provider, podcast provider, a VOD service, an OTT service, a content storage and delivery service, a third-party presentation settings provider, a computing device advertising network, a media distribution network, a cloud computing network, a local area network (LAN), a wide area network (WAN), a terrestrial network, a mobile network, and/or any combination thereof.

Presentation devices 105a-n may include any type of device capable of receiving and/or presenting content to a viewer or other content consumer. Non-limiting examples of presentation devices include televisions, smart televisions, laptops, PDAs, table computing devices, smartphones, PCs, display monitors or terminals, radios, audio devices, speakers, headphones, haptic devices, electronic reading devices, LED devices, OLED devices, wearable screens, set-top-boxes, satellite receivers, VOD receivers, content receivers, or the like.

In some aspects, the service provider 115 may include a network for transmitting content directly from the content provider 125a-n to the presentation devices 105a-n. For instance, the service provider 115 may include a network and associated technology for a television production studio to provide content directly to presentation devices 105a-n. In another instance, the service provider 115 may include a content access application and associated hardware and software for allowing a user to access content from various content providers 125a-n, including streaming services, OTT services or the like. In some aspects, the content providers 125a-n may communicate directly with the presentation devices 105a-n, for example, through the network 110.

The display adaptation system 100 may include and/or have access to one or more data stores 120. The data stores 120 may be configured to store content and or information that may be used by the presentation devices 105a-n, service providers 115, and/or content providers 125a-n for the creation, transmission, and/or presentation of the content. In some aspects, the data stores 120 may at least partially include data from third parties. For instance, the data stores 120 may include information associated with the number and types of presentation devices 105a-n receiving content through the service provider 115 and/or the network 110, presentation device 105a-n presentation settings, content presentation device 105a-n operating systems, software, firmware, and/or hardware, viewer or other content consumer and/or consumer device profiles (including preferences, such as content presentation preferences), content creator presentation settings or recommendations relating thereto (e.g., the recommended presentation settings as specified by the studio that created the content, etc.), information and/or applications for translating presentation settings into presentation instructions capable of changing the presentation settings of a particular presentation device 105a-n.

FIG. 2 depicts exemplary presentation settings for a presentation device according to some aspects of the disclosure. As shown in FIG. 2, a presentation device 205 may have various presentation settings 210 (device presentation settings) configured to specify how the presentation device 205 may present content to a viewer or other content consumer. The presentation settings 210 may be implemented in hardware and/or software to control the content presentation elements and/or hardware to present content according to the presentation settings. Conventional technology may allow a user to access the presentation settings 210 through a menu or voice-activated system. In some aspects, the presentation settings 210 may be accessed and/or changed through software and/or hardware instructions. In some aspects, the presentation settings 210 of a presentation device 205 may be modified by a separate device, such as a computing device (e.g., smartphone, tablet computing device, smart remote, smart-assistant, or the like.)

The presentation settings 210 may include any type of setting capable of specifying the presentation of content through the presentation device 205. The presentation settings 210 may be configured based on the type of presentation device 205 and/or content presentation elements, hardware, and/or software associated therewith. For a visual display presentation device 205 (e.g., any type of presentation device 205 configured to present visual content through a screen), illustrative settings may include, for example and without limitation, those listed in Table I, above. For a presentation device 205 capable of presenting audio content, illustrative settings may include, without limitation, volume, treble, bass, fade, balance.

In some aspects, the presentation settings 210 may include presentation modes that include pre-configured presentation settings generally directed toward specific types of content, such as sports or movies, or presentation features, such as vivid, soft, or dark. For example, a “Sports” setting made adjust certain audio/visual characteristics of the display to enhance the presentation of a certain sporting event further based on the device manufacturers' opinions. The nature of certain live sporting events might call for enhanced brightness and/or greater contrast to present a clearer picture of fast-paced action. Contrastingly, a setting such as “Movie” may decrease the sharpness and brightness of the display to provide a more cinematic presentation like a viewer would experience in a movie theater.

Many of these preset modes, however, often go unused due to the inconvenience to the viewer of switching back and forth between settings and the time-consuming nature of the operations. For example, to switch presentation modes a viewer may have to progress through several menus and other procedures to locate and select the desired mode. Additionally, if the viewer wants to change channels or surf through the available programming content, to fully maximize the viewing experience the viewer must re-configure, or apply a new preset mode, with every channel the viewer decides to watch.

Further, conventional preset modes, however, suffer from numerous technical drawbacks as they are not able to take advantage of unique differences in the content itself, the conditions under which the content was captured or produced, or the optimum presentation settings as envisioned by the content creators and producers themselves. A setting such as “Movie” is limiting as there are many filming/capture styles of the varied producers and cinematographers that cannot be accounted for in a single preset mode.

As another example, not all sports require the same setting adjustments as defined by the manufacturers' preset mode. Different sporting events will require different settings for optimum results, including frame rate, daytime/nighttime production, or the like. An indoor event versus an outdoor event may require variable settings control. A “Sports” setting typically has one set of parameters for that mode. Many sports however, are not filmed in identical conditions. An outdoor daytime football game may be better viewed with one set of presentation parameters, while an indoor hockey game may be best viewed with another set of presentation parameters. The limited number of presentation modes on a display cannot account for such differences of conditions within the already-selected mode. Additionally,

Additionally, not all presentation devices are alike. Presentation devices, whether it be a smartphone, tablet, LED display, LCD, display, OLED display, or the like, rely on vastly varying technologies, including panel types, CPU's, software, or the like. Even two devices, of the same size and display technology, but made by different manufacturer's will have many different settings that can be adjusted.

In some aspects, content may be encoded to include the provider presentation settings and/or presentation instructions relating thereto for the particular piece of content (e.g., forming a “media package”). For instance, a content provider 125a-n or other content creator may determine provider presentation settings for content, for example, to optimize the user experience of consuming the content. The provider presentation settings may be formatted, translated, or otherwise changed into presentation instructions that may be handled by the various devices that may transmit, receive, or otherwise access the presentation instructions.

For example, the provider presentation settings for a particular piece of content may be translated into presentation instructions that may be read by a particular presentation device or the operating system, hardware, and/or software thereof to actually cause a change in the presentation settings. A television program for a sporting event may be transmitted with presentation instructions instruction the destination television to switch to a “Sports” display mode when tuned to the television program. In another instance, a VOD movie may be downloaded to a presentation device (or television, smart television, smartphone, tablet, or the like) with presentation instructions instructing the presentation device to set the brightness to a certain value and/or range of values when playing the movie. The presentation device may revert back to original settings when not watching the movie or if another event occurs (e.g., decreasing the brightness level if a “low battery” event occurs).

As used herein, the provider presentation settings may be, include, and/or take the form of presentation instructions in a configuration profile. Accordingly, description herein involving transmitting, receiving, configuring, setting, determining, specifying, or otherwise associating with a configuration profile may include the presentation instructions associated therewith. For instance, transmitting a configuration profile may include transmitting the provider presentation settings, the presentation instructions for the presentation device to adapt the display, and additional data as disclosed herein.

In some aspects, the configuration profile may be transmitted over a broadcast network or the Internet (e.g., through service provider 115 and/or network 110) to a presentation device 205 to change the presentation settings of the presentation device 205. In one non-limiting example, a portion of a content stream may include a configuration profile package detailing certain audio/visual display settings (i.e., the provider presentation settings and presentation instructions for implementing the presentation settings) specifically tailored to the particular content being streamed. In some aspects, a content package may be downloaded to or otherwise accessed by a presentation device 205, including a similar configuration profile with the tailored audio/visual settings (i.e., the presentation settings 210), and presentation instructions for implementing the presentation settings.

In some cases, a configuration profile may be generated for a specific piece of content or in some cases for a “neighbor” (e.g. another episode of the same series, or otherwise related content) such that the configuration profile might be copied or algorithmically generated. According to one aspect, if there is no literal match, there may be an algorithmically identified other piece of content or an algorithmic means to determine a new configuration file.

According to certain aspects, the configuration profile may be transmitted separately from the content itself. For example, while a content asset may be acquired over a broadcast channel, the configuration profile may be requested and acquired over a separate channel, network, or other interface, such as the Internet, a side-loaded media device, or the like. As described herein, the presentation device 205 may receive the configuration profile and adapt the presentation display according to the presentation instructions concurrently with the request and acquisition of the content asset such that the playback is displayed according to the presentation instructions and settings from the start of the content.

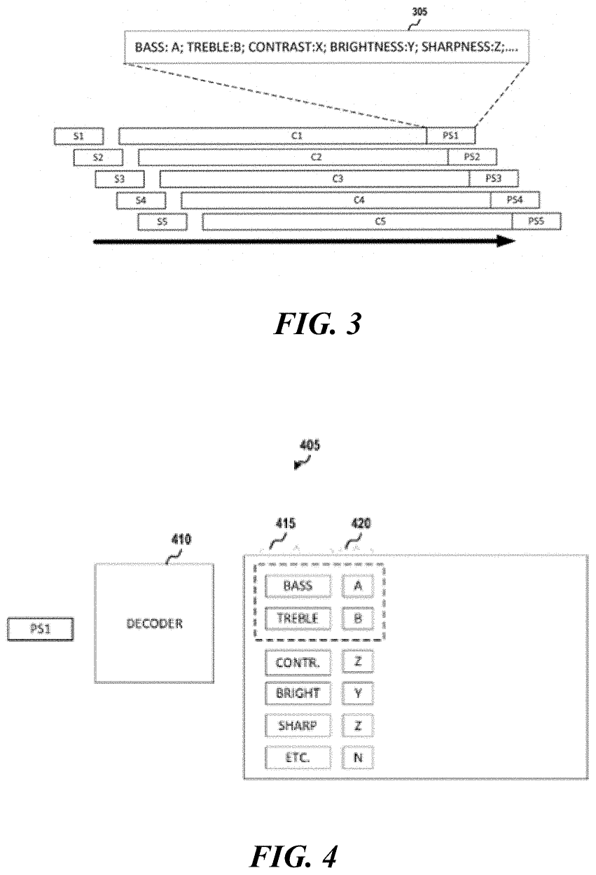

FIG. 3 depicts an illustrative content delivery configuration providing presentation settings. As shown in FIG. 3, a plurality of content streams or channels S1-S5 (“content streams”) may be transmitted to a presentation device (not shown), such as presentation devices 105a-n and/or presentation device 205. The content streams S1-S5 may include content packages C1-C5 configured to provide content to a presentation device. The content packages C1-C5 may include and/or may be associated with configuration profiles PS1-PS5. As disclosed herein, while the configuration profiles PS1-PS5 shown in FIG. 3 may be transmitted with content packages C1-C5, other acquisition and delivery interfaces may be implemented to provide the configuration file, provider presentation settings, and/or presentation instructions.

In some aspects, the configuration profiles PS1-PS5 may include various settings and values therefor for specifying the provider presentation settings of a destination presentation device. In some aspects, the configuration profiles PS1-PS5 may include information for implementing the provider presentation settings on one or more particular types of presentation devices. For example, the configuration profiles PS1-PS5 may include information for different types of televisions, such as different presentation settings and/or software and/or hardware instructions for different brands, models, resolutions, scaling, aspect ratio, high definition characteristics (e.g., high definition (HD), ultrahigh definition (UHD), 4K, 8K, HDR, standard definition, and variations thereof), and sizes of televisions. For example, media content recorded and created for 4K resolution may also include or be associated with provider presentation settings for scaling such content to a lower resolution. In another example, the configuration profiles PS1-PS5 may include information for different types of devices, such as different presentation settings and/or software and/or hardware instructions for a television, a tablet computing device, a smartphone, etc. for the same content package C1-C5. In this manner, a content package C1-C5 may be transmitted to a plurality of presentation devices and may include the configuration profiles PS1-PS5 for configuring the different types of presentation devices in one set of configuration profiles PS1-PS5.

In some aspects, the configuration profiles PS1-PS5 for a content package C1-C5, or other requested content asset may be specific for a particular type or class of presentation device (e.g., televisions, tablet computing devices, smartphones. Additionally, the configuration profiles PS1-PS5 may be specific for a presentation device of a specific manufacturer. For instance, a first content package C1 may have a configuration profile PS1 for a particular television (defined by manufacturer, model number, dimensions, display technology, resolution, or the like), while a second content package C1′ may include the same content as content package C1, but may include a different configuration profile PS1′ for a different type of television or a different type of device (e.g., a tablet computing device).

FIG. 4 depicts an illustrative presentation device according to some aspects. As shown in FIG. 4, provider presentation settings in the form of a configuration profile PS1 may be received by a presentation device 405. The presentation device may have a decoder 410 configured to decode the configuration profile PS1 received by the presentation device 405 (e.g., through a receiver, tuner, processor, communication port, or the like). The decoder 410 may be implemented in hardware, software, or a combination thereof. In some aspects, the decoder 410 may be a native or integral software application and/or hardware element of the presentation device 405. In some aspects, the decoder 410 may include a third-party hardware and/or software element. For example, the decoder 410 may include a software application configured to operate on the presentation device 405 and/or a computing device in operable communication with the presentation device 405 (e.g., a tablet computing device in communication with a television or set-top-box). In another example, the decoder 410 may include a hardware device (e.g., a dongle or drive) configured to connect to the presentation device through a communication interface (e.g., a universal serial bus (USB) port, an HDMI port, an Ethernet port, a wireless (WiFi) communication element, Thunderbolt, Optical, Bluetooth, SD card, NFC, RF, or the like). In some aspects, the configuration profile PS1 may be transmitted and implemented via visual indicators, such as device readable or scannable bar codes, quick response (QR) codes, or through Bluetooth®, near field communication (NFC), or other communication protocols.

The decoder 410 may be configured to recognize, read and reconfigure the provider presentation settings 415 of the presentation device 405 based on the presentation instructions included in the configuration profile PS1. For example, when the a content asset is chosen by a viewer, such as through a tuning operation on a cable or satellite box, or selected by the user via a browser or on-demand service, the decoder 410 may be configured to identify the configuration profile PS1, read the presentation instructions and various data settings included in the profile, and cause the display to automatically configure the audio/visual settings listed in configuration profile PS1 to the defined values of the provider presentation settings.

In some aspects, such a configuration operation may occur automatically and may be “invisible” to the viewer. In other aspects, the display adaptation system may provide an informative message to indicate to the viewer that certain settings have been applied (and may require an affirmative selection or rejection, or default to an automatic selection after a predetermined time period.

In some aspects, the configuration PS1, may be defined by the content creators or editors when the content is prepared for dissemination to service providers, networks, or directly to presentation devices 405. As such, the settings defined in the configuration profile PS1 may be well-defined and chosen by professionals for determining the optimal settings in which to consume the given content. In some aspects, as described herein, the configuration profile PS1 may be determined and/or modified based on a sensor configured to detect user or environmental conditions associated with the presentation device 405. In some aspects, the configuration profiles PS1-PS5 may be determined and/or modified based on a user profile and/or user preferences associated with a viewer and/or a presentation device. In some aspects, the configuration profiles PS1-PS5 may be determined and/or modified based on third party users, such as preferred and/or suggested settings obtained through Internet services (e.g., websites, social network services, blogs, etc.).

In some aspects, user settings for a content asset may be transmitted to an entity or application configured to generate provider presentation settings in order to allow the entity and/or application to learn user presentation settings for a content asset for the generation of future provider presentation settings for use with the same content asset or other content assets.

As described above, audio settings may also be configured via the configuration profile PS1. In an aspect where the audio capabilities are internal to the presentation device 405, such as devices with internal speakers, etc., the audio characteristics may be configured via the presentation device 405 itself. In a presentation device 405 which includes external audio capabilities, such as an external home theater receiver, the external home theater receiver may also receive similar provider presentation settings to recognize, read and reconfigure the external speakers based on the data from the configuration profile PS1. The presentation device 405 may be further configured or instructed to communicate with the external audio capabilities to specify the configuration profile PS1 thereof. As another example, where a location is audio sampled and then those samples are used us to recreate the audio dynamics of that location. As a further example, a concert recorded in the Notre Dame Cathedral might initiate sound processing to make the playback appear to be in the Notre Dame Cathedral.

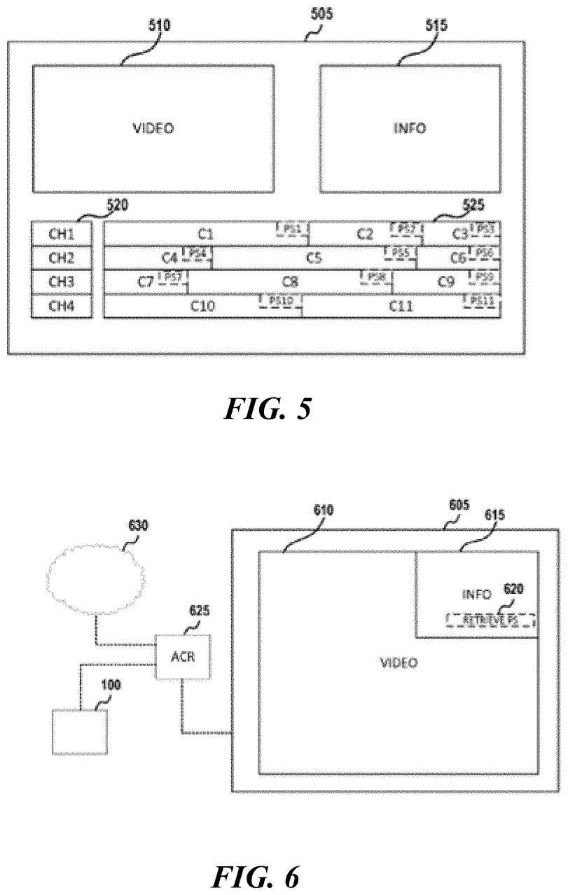

FIG. 5 depicts a programming guide for providing presentation settings according to some aspects. As shown in FIG. 5, a programming guide 505 (e.g., an electronic programming guide (EPG)) may be configured to provide configuration profiles PS1-PS11 to a user accessing the EPG 505 through a presentation device and/or a device in communication with a presentation device (e.g., the EPG 505 is accessed through a tablet computing device operably coupled to a television). The EPG 505 may include a channel list 520 and associated content listing 525 for each channel. The channel list 520 may include content from multiple content sources, such as broadcast channels (including past and future broadcast content), VODs, DVRs, PVRs, computing devices (e.g., content stored on computing devices), and multiple content providers. The EPG 505 may be configured to present visual content 510 (e.g., images, videos, trailers, promos, etc.) and information 515 associated with content, such as a selected content item in the content listing 525. The EPG 505 may include additional features known to those having ordinary skill in the art.

The content C1-C11 accessible through the EPG 505 may be associated with configuration profiles PS1-PS11. In some aspects, the configuration profiles PS1-PS11 may be included in the metadata obtained by the service provider to populate the electronic programming guide. In some aspects, a viewer may tune to or select content C1 and the presentation device may be configured to recognize and read the data from the configuration profile PS1 attached to the program guide information. Responsive to receiving (and decoding as necessary) the presentation settings, the display of the presentation device may be automatically re-configured according to the values listed in the provider presentation settings of configuration profile PS1. In some aspects, the selection of content C1 through the EPG 505 may invoke a prompt requesting whether the user would like to implement the presentation settings of configuration profile PS1 (see, for example, prompt 620 of FIG. 6).

In some aspects, the selection of content C1 through the EPG 505 may invoke a prompt requesting whether the user would like download or otherwise access the corresponding configuration profile PS1, for example, from a third party (e.g., the content creator, the service provider, the presentation device manufacturer, or a specialized service for providing such information).

FIG. 6 depicts a request interface for video content according to some aspects. As shown in FIG. 6, video content 610 may be presented through a presentation device 605. In some aspects, the provider presentation settings may be determined and/or modified automatically based on characteristics of the content asset and/or information associated with the content asset (e.g., provided by a service provider, content distributor, and/or a third party), such as presentation settings or presentation instructions. In some aspects, the provider presentation settings may be determined, modified, and/or accessed based on content recognition information, such as through automatic content recognition (ACR) processes. In some aspects, a computing element 625 in operable communication with the presentation device 605 may be configured to facilitate content recognition. In some aspects, the computing element 625 may include software (e.g., a software application such as a mobile app, smart television application, or the like) and/or hardware (e.g., a processor and/or other circuitry configured to provide content recognition capabilities alone or in combination with software). In some aspects, the computing element 625 may be integral to the presentation device (e.g., hardware and software within a smart television, tablet computing device, or the like). In some aspects, the computing element 625 may be integrated in a first computing device (e.g., a tablet computing device) in operable communication with the presentation device 605. In some aspects, components of the computing element 625 may be operable in a computing device and other components may be operable in the presentation device (e.g., software on a tablet computing device configured to control and/or interface with hardware and/or software components of a presentation device).

In some aspects, the computing element 625 may be resident in the service provider, content provider, a presentation device 605, or some combination thereof. The computing element 625 may be in operable communication with a content distribution system 100 and/or components thereof (e.g., service provider 115, content provider 125a-n, a presentation device 105a-n, and/or data stores 120 of FIG. 1). In some aspects, the computing element 625 may be in operable communication with other networks 630, including a distributed computing network or cloud computing network or data storage system (the “cloud”).

In some aspects, information associated with the content asset (e.g., video content 610) may be obtained from a data source containing data concerning the content asset and/or similar content assets, the cloud 630, or it may be determined based on analyzing the actual content asset. For example, the computing element 625 may be configured to receive and/or determine a water mark, footprint, signature, or other characteristic of the content asset being presented through a presentation device (e.g., through ACR techniques), such as video content 610 being presented through presentation device 605.

In another instance, the content asset may be analyzed to determine certain characteristics that may relate to the recommended or optimal presentation settings, such as type of content asset (e.g., broadcast television video, web-based video, VOD video), subject or category (e.g., sports, movies, genres), presentation characteristics (e.g., light levels, sound levels, colors). In some aspects, the provider presentation settings may be determined and/or modified based on the content recognition information.

In some aspects, content recognition may be a dynamic process configured to automatically and dynamically change the presentation settings of a presentation device 605 based on the determined presentation characteristics of the content asset as it is being presented through the presentation device 605. In some aspects, the device information may include data and/or instructions for dynamically adjusting the device presentation settings over the duration of consumption of a content asset or due to content switching (e.g., different presentation instructions for a television program and different presentation instructions for intervening commercials). For example, the provider presentation settings may have increased brightness for a darker scene in a movie and may have decreased brightness for a lighter scene in the movie. Accordingly, different content segments received by a presentation device 605 (such as program and commercial segments) may be associated with different provider presentation instructions and settings.

A graphical user interface (GUI) element 615 (e.g., an overlay, a banner, pop-up, transparent window, etc.) may be presented on the screen of the presentation device 605 with an option 620 to select the provider presentation settings associated with the content. For example, a viewer may initiate viewing of a movie through a television, such as a smart television, or a tablet computing device. The movie may be accessed through various sources described herein. The computing element 625 may analyze the movie or otherwise access or receive information associated therewith in order to recognize the movie, content of the movie, or characteristics thereof. For instance, the computing element 625 may access a watermark, fingerprint, signature, or other data element encoded in or otherwise associated with the movie. Responsive to accessing the watermark, the computing element 625 may communicate with the cloud 630, a content distribution system 100, or components of a content distribution system 100 to identify the content and/or to obtain provider presentation settings relating thereto. The presentation device 605 may receive the provider presentation settings and/or provide a prompt 620 to implement and/or download the provider presentation settings.

In some aspects, the computing element 625 may transmit a request to the cloud 630, the content distribution system 100, or components of the content distribution system 100, that may include the identified content and/or address (e.g., IP or MAC address) or other identification information (e.g., provider subscriber identifier) for the presentation device 605. In response, the relevant component of the cloud 630, the content distribution system 100, or components of the content distribution system 100 may transmit provider presentation settings or configuration profile to the presentation device 605, for example, through the computing element 625 or communication components of the presentation device 605. In this manner, a user may automatically access, implement, and/or receive provider presentation settings without having to actively search or intervene in the process.

In a non-limiting example, a user is watching a television program on a smart television through a streaming service. The television program may have a watermark encoded in the transmission thereof. The watermark is detected by a software application operating on the smart television. The detection of the watermark may trigger the software application to transmit a request to service provider database or other storage. As disclosed herein the service provider may be any of the content creator, producer, distributor, or other party providing such information. The request may identify the television program and provide an IP address and presentation device information for the smart television. The service provider may receive the request and perform a lookup for the recommended provider presentation settings for the television program and particular presentation device (and/or additional identifying information, such as display size (or range thereof), manufacturer, model number, and/or other characteristics (e.g., HD, UHD, or the like)). The service provider may transmit a configuration profile including presentation instructions associated with the recommended provider presentation settings for the presentation device to the IP address. The presentation device receives the presentation instructions and may provide the user with a prompt to select to implement the provider presentation settings (alternatively, the user may provide a default setting to always implement the provider presentation settings without a prompt). The presentation device, through a combination of software and hardware, may implement the provider presentation settings responsive to the user selection to adjust the presentation settings of the presentation device.

In some aspects, a user may be given the option to retrieve the optimal presentation settings from the content provider, service provider, and/or other third party provider that may specialize in enhancing audio/visual settings, such as the device manufacturer, or a third-party device settings entity. Additionally, if multiple service providers offer a configuration profile or provider presentation settings, the user may be presented with the choice of selecting the desired provider.

In some aspects, access to and/or the automatic configuration of presentation settings may be offered as a premium or fee-based service, for example, by a service provider, a content provider, and/or a third-party. For instance, a cable or satellite provider, or internet subscription service, may offer the capability of the enhanced audio/visual settings for subscribers who choose to pay an additional fee.

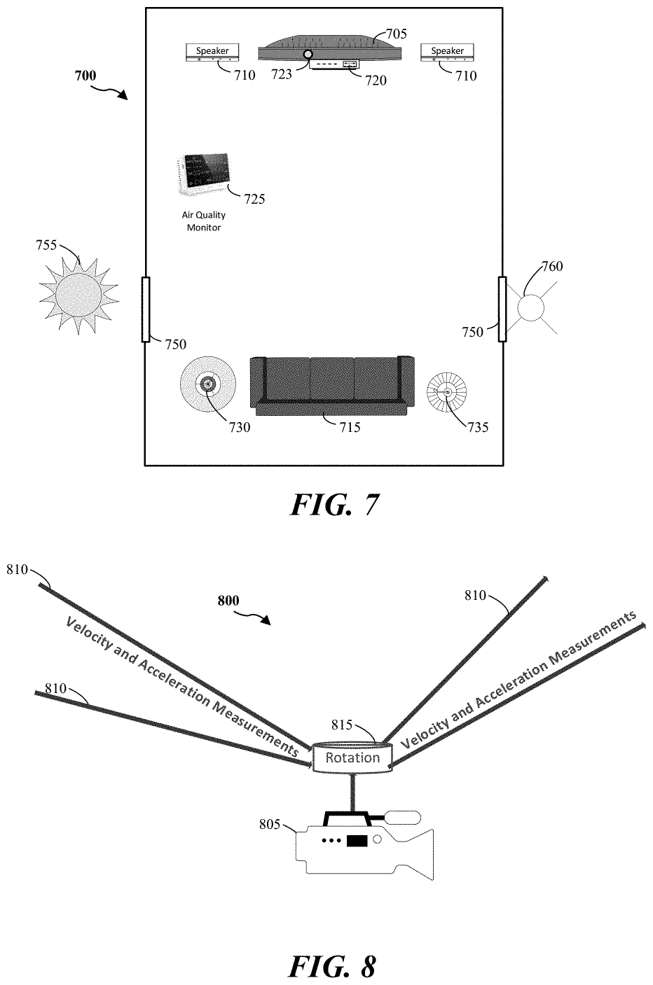

FIG. 7 depicts an exemplary content presentation environment 700, according to certain aspects of the disclosure. The environment 700 may include a presentation device 705, one or more speakers 710, a couch 715 or other seating on which a viewer may sit to view the content, and a number of light sources, including for example a floor lamp 730, a table lamp 735, and one or two windows 750, through which external light sources such as the sun 755 or nighttime streetlight 760. According to certain aspects of the disclosure, one or more sensors may be present in the environment 700 and operatively coupled to the presentation device 705. For example, an ambient light sensor 720 and/or a microphone 723 may be integrated or otherwise operatively coupled to the presentation device 705. As another example, an air-quality monitor 725 may also be present in the environment 700 and operatively coupled to the presentation device 705. According to another aspect, sensors may be included in home control devices, assistance or Internet-of-Things (JOT) configured devices.

In some aspects, a sensor may be operatively coupled to the presentation device (e.g., operatively coupled to a processor or other hardware of the presentation device). In some aspects, the sensor 215 may not be operatively coupled to the presentation device 205. In some aspects, the sensor 215 may be in communication with at least a portion of the display adaptation system 100, such as another presentation device 105a-n (e.g., a computing device in communication with a television), the service provider 115, the network 110, a content provider 125a-n, or any combination thereof. In this manner, the information obtained by the sensor 215 may be used to specify the presentation settings 210 according to some aspects.

According to aspects of the disclosure, environmental conditions in which the content is being presented may be used to adapt the presentation settings of the presentation device 705 for optimal display of the content. Environmental sensors may include any type of sensor capable of measuring or otherwise obtaining information that may relate to the presentation settings and/or the optimization or configuration thereof. Non-limiting examples of sensors may include a photo sensor, a light sensor, a decibel, a temperature sensor, and a motion sensor. In some aspects, data from the sensor may be used to adapt or further adapt the presentation settings to ensure a quality display.

One such sensor may include the ambient light sensor 720 implemented to detect ambient lighting conditions. The ambient light sensor 720 may report its readings to the presentation device. A configuration file, including provider presentation settings for a corresponding ambient environment, may be requested and transmitted to the presentation device 705.

According to one aspect, the ambient light sensor 720 may be used to detect the amount of ambient light and the microphone 723 may detect sound characteristics that can be used to request and configure the provider presentation settings further. For example, ambient light sensor 720 may be a photo sensor, or light meter, disposed on or near the display may detect the amount of light incident on the display of the presentation device 705. Data from the ambient light sensor 720 may then be used to adapt the display according to the provider presentation settings, typically the brightness level to further to ensure a quality display without any consideration for how the content was originally designed to be viewed. Such a configuration may be implemented to reduce or eliminate eyestrain.

According to one aspect of the present disclosure, the display adaptation system may include a specific configuration profile that is pre-calculated for a given amount of ambient light. The configuration profile, in addition to the pre-calculated ambient light reading, may further include the particular presentation device or display model and the identification of the content being viewed.

According to one aspect of the disclosure, a content provider, content creator, service provider or the like may determine a number of provider presentation settings. The ambient light detector 720 may report, along with the content information and the specific presentation device 705 (or display) type to fetch the configuration profile with the precalculated provider presentation settings. The appropriate configuration profile file is then transmitted back to the presentation device 705 for a content asset according to ambient light levels in which the content should be viewed. For example, a content provider may define three setting profiles each defining different provider presentation settings. Setting profile configurations may be created for a low light, medium light, and high light conditions. In such setting profiles, display settings, including without limitation, those listed in Table I, above, may be set for optimal viewing given a received reading from the ambient light sensor 720 according to one of the three setting profiles. If a low light ambient detection is sent from the presentation device 705, the provider presentation settings corresponding to the low light settings may be sent in the configuration profile to be applied to the presentation device 705.

According to one aspect, content creators may define a setting profile and corresponding provider presentation settings according to how the creators believe the content should be viewed and under a limited number of lighting conditions. For example, a content creator may experimentally observe the content in low, medium and high light level while determining the optimal presentation settings for each light level. Those setting profiles may be stored and sent, as part of a configuration profile or separately, when the content is being played by a viewer and matched to a light level as detected and reported by a ambient light sensor 720.

Further, while an infinite number of setting profiles may be created for an infinite number of ambient light sensor levels, it may not be practical to do so. As such, according to one aspect, a display adaptation system may derive, interpolate or algorithmically generate an intermediary set of provider presentation settings based on bounding levels of the detected ambient light. For example, if the ambient light sensor 720 detects and reports a light level between a low level and medium level, the system may intelligently identify the closest profile to the detected level and interpolate between the two profiles to generate an ad hoc setting profile. The ad hoc setting profile may include dynamic adjustments to the profile settings previously defined to alter the display settings for a more optimal viewing experience. If the detected light level is closer to the low light threshold, the ad hoc setting profile may adjust the settings to be more similar to the low light profile, with certain adjustments to account for the increased light level.

According to one aspect, for example, an on-demand or streaming program may be requested by a viewer. Either as part of the request, or as subsequent transmissions, device information, including information such as, without limitation, manufacturer, model, size, display panel technology, backlighting, and the like, and an ambient light level may be sent to the content provider. The ambient light level may be obtained from the ambient light sensor 720 on board the presentation device, or may be obtained from a separate, but communicatively coupled sensor. Upon receipt of the ambient light level, the display adaptation system may generate, request or retrieve a setting profile, as part of a configuration profile or separately, corresponding to the presentation device 705, the light level and the chosen content. The setting profile may be obtained from any number of sources including but not limited to, the content creator, service provider, collected viewer data or the like. The system may obtain a configuration profile including a setting profile according to a closest match of the light level, (low light, medium light, high light) as described above. The system may further interpolate between the closest match and the next closest match in order to adapt the display settings more optimally to the content and environment in which the content will be viewed. According to one aspect, for example, a mean value theorem may be used to interpolate between two pre-defined setting profiles. The configuration profile and/or setting profile, may be transmitted with or without and/or within or external to the content transmission. As a result, the content and instructions are received by the presentation device 705 to configure the presentation settings according to the current configuration profile. According to one aspect, the provider presentation settings may be applied according to the presentation instructions such that the transitions between content and/or changes in the content are executed smoothly with little or no perception by the viewer.

According to one aspect, the ambient light sensor 720 may periodically and/or continually monitor and report the lighting conditions in the environment so that, if the ambient lighting changes, the display adaptation system may accordingly request, acquire, adjust and/or apply new or updated provider presentation settings. For example, if the playback of a content asset beings in the afternoon when light from the sun 755 through windows 750 via present in the environment, but as the content continues to play, the sun 755 may set giving way to either darkness or external light from the streetlight 760, an updated configuration profile may be requested and applied to account for the change in ambient lighting. Similarly, turning on or off any of the internal light sources, such as floor lamp 730 or table lamp 735, may cause the ambient light sensor 720 to report a change in lighting, and causing the system to request an updated configuration profile according to the updated ambient light conditions. According to one aspect, a delay may be implemented in the environmental sensors such that if the detected change is only present for a brief period of time, (e.g., a lamp is briefly turned on and off again within a short period of time) no change will be requested.

According to one aspect, additional environmental sensors may operate separately or in conjunction with the ambient light sensor 720 to detect and report additional environmental conditions that may cause a desired change in the provider presentation settings. For example, the microphone 723 may continually monitor the sound in the environment for an echo, or other ambient noise. The air quality monitor 725 may continually monitor the ambient air conditions for smoke, CO, CO₂, or the like, for changes to air conditions that may affect how the content is being viewed and consequently how it may be adapted, via a change to the provider presentation settings, to ensure optimal viewing.

According to another aspect of the present disclosure, a presentation device may be adapted or tuned to optimally display a content segment according to exogenous data and/or metadata related to the content and its transmission. Rather than relying solely, or in part, on the content itself to optimize the display settings, aspects of the present disclosure include the collection, processing and adaptation of display settings using data relating to who, where, when, and how the content itself was created.

As used herein, exogenous data may include data and metadata relating to and about who, where, when, and how the content being displayed was created, produced or otherwise edited. Non-limiting examples of such data may include, camera-type, camera settings, camera position, camera motion, camera rotation (e.g., use of a jib, wire hung camera, handheld Stedicam, SkyCam, or the like) lens type, focus settings, lighting settings, location, time of day, date, or the like. According to one aspect, this exogenous data may be appended to the content being transmitted, included in a configuration profile as part of the provider presentation settings, or transmitted separately, and may be used to adapt the presentation settings on the presentation device displaying the content.

In certain high-speed content transmissions where an object may be moving faster than the frame rate or refresh rate can capture, traditional systems rely on complex interpolation and estimation techniques to provide image continuity or “smooth” the content for transmission and display. Such image processing is computationally expensive and may be unreliable, and may create and undesirable viewing experience contrary to what the content creator envisioned for their work.

On the other hand, knowing additional details and data relating to how the content was created may provide significant advantages in transmitting and displaying the content on a presentation device in its optimal settings. Knowing and incorporating the details about how the content is captured and/or edited, including camera settings, camera motion, camera rotation, and the like, to name a few, may eliminate the need for complex computations and inaccurate or distorted estimates. Aspects of the display adaptation system may allow the content to be displayed in a truer form, according to both reality and how the content creator envisioned the content to be consumed or will be consumed as in a live production, or combination of live and pre-recorded content.

According to one aspect, a display adaptation system may receive the content with the included exogenous data as a portion of a configuration profile. The system may determine from presentation instructions associated with the exogenous data how to optimally adapt a display of the presentation device and its settings for optimal playback. According to one aspect, the system may reside on the presentation device itself, or it may reside upstream from at a broadcast or service provider server. If the adaptation system resides on the presentation device itself, the device may receive and analyze the exogenous data with the content, determine the optimal display settings, and adjust the display according to the determined settings.

If the adaptation system resides outside of the presentation device, a request may be made to the presentation device querying the device for information necessary to adapt the display. Such information may include, without limitation, device type, display size, manufacturer, model-no, serial number, available display settings, or the like. The adaptation system may use this information to determine the appropriate settings for the presentation device. Once the appropriate settings are determined, they may be appended to the content as part of a data stream or configuration profile. The presentation device, upon receiving the content may process the provided presentation instructions, including provider presentation settings based on the exogenous data, to adjust the display settings prior to initiating (or concurrently with) displaying the content.

According to one aspect, of the disclosure, the provider presentation settings may be segmented with the content such that the provider presentation settings may be adapted in the middle of a presentation. The exogenous data may be segmented, or include segment information, regarding a change of scenery, lighting, sound, capture style, focus information or other change that may necessitate a modification of the presentation settings to maintain optimal display of the content. For example, if a particular scene of a movie is filmed at night and a subsequent scene is filmed the next day in daylight, the exogenous data may reflect such a change and the adaptation system may process such data to be able to dynamically and seamlessly adjust the display settings on the presentation device at the scene change to a new set of optimal provider presentation settings.

Similarly, the adaptation system may take advantage of exogenous data in presenting live broadcasts or presentations. Consumption [GH1] of live content presentation may present uncertain and unknown conditions including lighting changes, weather, spontaneous events or the like.

According to an aspect of the present disclosure, exogenous data may be frequently updated and processed by the adaptation system to adjust the provider presentation settings as a live event is being viewed. For example, if a sporting event, such as a football game begins under sunny and bright weather conditions, but subsequently extends into nightfall (or a rain or snow storm), the exogenous data which may include lighting conditions at the field, weather information, time or day, sunset data, or the like, may be updated and processed to adapt the presentation settings mid-game to optimize the display of the content.

FIG. 8 depicts a conceptual content capture device 800 in which exogenous data may be generated, captured and used to generate provider presentation settings according to one or more aspects of the present disclosure. The content capture device 800 may include an imaging device 805 such as a camera, for capturing, storing, and/or transmitting content. The imaging device 805 may include or be coupled to one or more motion devices, such as a rotation device 815 and/or one or more cables 810. The imaging device 805 may be controlled remotely using the cables 810 and rotation device 815 to position the imaging device 805 in a desired location and pose. Particularly for live content capture, such as a football game or other sporting event, the imaging device may be moved and aimed at high speeds tracking the action of the game. Exogenous data including, for example, the velocity, acceleration, rotation speeds and rotation angles of the imaging device, may be captured and used to generate optimal provider presentation settings for content captured by the imaging device. According to one aspect, the exogenous data may be used to generate provider presentation settings to be included in a configuration profile transmitted to the presentation device. The provider presentation settings may be transmitted with presentation instructions that, when executed, apply the provider presentation settings to the display of the presentation device when showing content captured by the imaging device 815.

According to another aspect, the exogenous data may include information supplied by the content creator indicating the optimal display settings to experience the content according to the creator's vision and desire. Such information may include script notes, lighting angles, lighting levels, refresh rates, frame rates, or the like. Providing such information may allow the content creators not only a way for consumers to truly experience the content as the creator intends, but also allows the creator another dimension of creativity in story-telling and presentation.

According to one or more aspects of the present disclosure, a set of display adaptation tools may be built and adapted using machine learning and artificial intelligence. In such systems, a learning module may record and learn how to automatically adapt display settings over time and multiple instances of the system processing exogenous data to optimize a display. For example, if certain content is created, yet no exogenous data is captured or recorded, a trained display adaptation tool may be able to adapt a display showing such content based on its previously learning of similar content. Such a system may be particularly beneficial for live transmissions where frequent updates to exogenous data may be computationally expensive or not possible given limitations of the transmission.

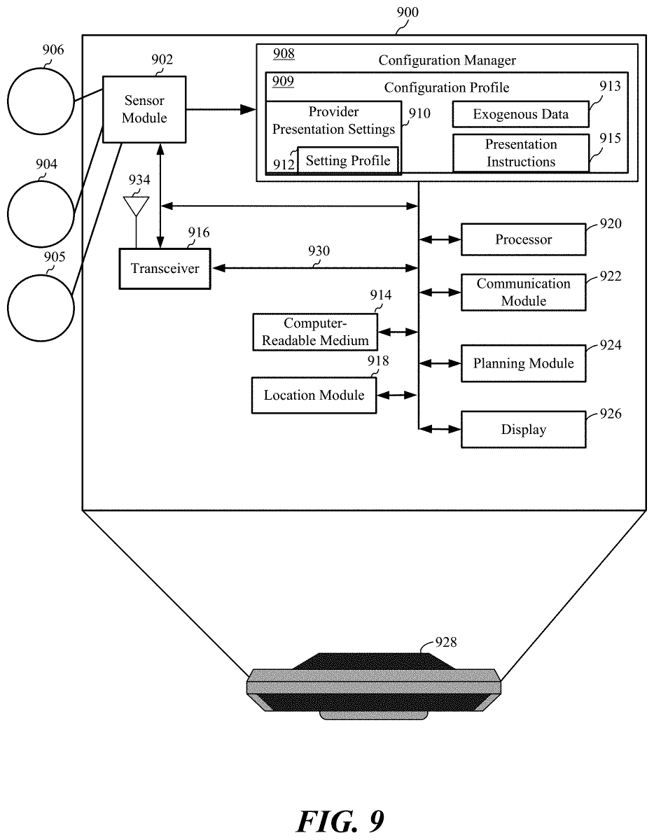

FIG. 9 is a diagram illustrating an example of a hardware implementation for a display adaptation system 900, according to aspects of the present disclosure. The display adaptation system 900 may be a component of a television, tablet, smartphone, or other computing device. For example, as shown in FIG. 9, the display adaptation system 900 is a component of a television 928. Of course, aspects of the present disclosure are not limited to the display adaptation system 900 being a component of the television 928, as other devices, such as a television, tablet, smartphone, gaming console, home theater system, or other presentation device, are also contemplated for using the display adaptation system 900.

The display adaptation system 900 may be implemented with a bus architecture, represented generally by a bus 930. The bus 930 may include any number of interconnecting buses and bridges depending on the specific application of the autonomous driving system 900 and the overall design constraints. The bus 930 links together various circuits including one or more processors and/or hardware modules, represented by a processor 920, a communication module 922, a location module 918, a sensor module 902, a display module 926, a planning module 924, and a computer-readable medium 914. The bus 930 may also link various other circuits such as timing sources, peripherals, voltage regulators, and power management circuits, which are well known in the art, and therefore, will not be described any further.

The display adaptation system 900 includes a transceiver 916 coupled to the processor 920, the sensor module 902, a configuration profile 908, the communication module 922, the location module 918, the display module 926, the planning module 924, and the computer-readable medium 914. The transceiver 916 is coupled to an antenna 934. The transceiver 916 communicates with various other devices over a transmission medium. For example, the transceiver 916 may receive commands via transmissions from a user or a remote device. As another example, the transceiver 916 may transmit information, such as presentation device information, from the configuration profile 908 to a server (not shown). According to one aspect, the configuration profile 908, as described herein, may be an offline system in communication with the inputs over a wireless network or wired interfaces, including USB, HDMI, Thunderbolt, Wi-Fi, Ethernet, Optical, Bluetooth, SD card, near-field communication (NFC), radio frequency (RF), or other communication interface.

The display adaptation system 900 includes the processor 920 coupled to the computer-readable medium 914. The processor 920 performs processing, including the execution of software stored on the computer-readable medium 914 providing functionality according to the disclosure. The software, when executed by the processor 920, causes the display adaptation system 900 to perform the various functions described for a particular device, such as the television 928, or any of the modules 902, 908, 914, 916, 918, 920, 922, 924, 926. The computer-readable medium 914 may also be used for storing data that is manipulated by the processor 920 when executing the software. The computer-readable medium 914 may be or include, OEM, downloadable to device as firmware or application software, controlled from a remote or intermediary server, on a USB stick or SD card, or in an outboard connected device as described herein.

The sensor module 902 may be used to obtain measurements via different environmental sensors, such as a first sensor 906, a second sensor 904, and a third sensor 905. The first sensor 906 may be an ambient light sensor, such as a photo sensor or light meter, for ambient light levels in the environment and/or incident on the display. The second sensor 904 may be an audio sensor, such as a microphone. The third sensor 905 may be an air quality sensor, such as a smoke detector, CO or CO₂ monitor, or another environmental sensor. Of course, aspects of the present disclosure are not limited to the aforementioned sensors as other types of sensors, such as, for example, motion, thermal, sonar, and/or lasers are also contemplated for either of the sensors 904, 905, 906. The measurements of the first sensor 906, the second sensor 904, and/or the third sensor 905 may be processed by one or more of the processor 920, the sensor module 902, the display adaptation system 908, the communication module 922, the location module 918, the display module 926, the planning module 924, in conjunction with the computer-readable medium 914 to implement the functionality described herein. In one configuration, the data captured by the first sensor 906, the second sensor 904 and the third sensor 905 may be transmitted to an external device via the transceiver 916. The first sensor 906. the second sensor 904 and the third sensor 905 may be integrated to the television 928 or may be in communication with the television 928.

The location module 918 may be used to determine a location of the television 929. For example, the location module 918 may use a global positioning system (GPS) to determine the location of the television 928. The communication module 922 may be used to facilitate communications via the transceiver 916. For example, the communication module 922 may be configured to provide communication capabilities via different wireless protocols, such as WiFi, long term evolution (LTE), 3G, 4G, 4G, or the like. The communication module 922 may also be used to communicate with other components of the television 928 that are not modules of the display adaptation system 900.

The display module 926 may be used to present content assets on the display of the television 928. The display module 926, in conjunction with the configuration profile 908 and sensor module 902, and other modules, may adapt the presentation settings of the television 928 according to provider presentation settings 910 and presentation instructions 915, as described herein.

The display adaptation system 900 also includes the planning module 924 for planning or scheduling the execution of the presentation instructions 915. Particularly for stored content or scheduled recording of content, the planning module 924 may in conjunction with the other modules of the display adaptation system 900 schedule a request and acquisition of a configuration profile based on the upcoming presentation of content or content recording. In one configuration, the planning module 924 may either override or submit to user input when the user input is expected (e.g., predicted) to apply a preset presentation mode or discrete presentation settings.

The modules of the display adaptation system 900 may be software modules running in the processor 920, resident/stored in the computer-readable medium 914, one or more hardware modules coupled to the processor 920, or some combination thereof.

The configuration profile 908 may be in communication with the sensor module 902, the transceiver 916, the processor 920, the communication module 922, the location module 918, the display module 926, the planning module 924, and the computer-readable medium 914. In one configuration, the configuration profile 908 receives sensor data from the sensor module 902. The sensor module 902 may receive the sensor data from the first sensor 906, the second sensor 904, and/or the third sensor 905. According to aspects of the disclosure, the sensor module 902 may filter the data to remove noise, encode the data, decode the data, merge the data, extract data, or perform other functions. In an alternate configuration, the configuration profile 908 may receive sensor data directly from the first sensor 906, the second sensor 904 and/or the third sensor 905.

As shown in FIG. 9, the configuration profile 908 may include provider presentation settings 910, as described herein. The provider presentation settings 910 may include one or more setting profiles 912, such as setting profiles 910 for one or more ambient lighting conditions, as described herein. The configuration profile 908 may also include exogenous data 913 relating to a content asset by which the provider presentation settings 910 have been selected and applied through presentation instructions 915. The presentation instructions 915 may include executable instructions or other information to be analyzed or executed by the processor 920 to apply the provider presentation settings 910 to the display module 926, and other modules of the television 928.

The configuration profile 908 may receive sensor information from the sensor module 902 and generate and transmit a request for provider presentation settings 910, via transceiver 916, to a service provider. The request may include presentation device information, including manufacturer, model number, size, display technology and the like, along with the identification of the content being (or about to be) presented. A service provider may receive the request, as described herein, and provide a configuration profile, including provider presentation settings 910, and presentation instructions 915 for implementing the provider presentation settings 910. The transmitted configuration profile may also include the exogenous data used to generate the provider presentation settings, or it may omit such information from the configuration profile.

Upon receipt of the configuration profile 909, the presentation instructions 915 may be decoded and executed by the processor 920 and the provider presentation settings 910 may be applied to the display module 926 of the television 926 to display the content asset. The planning module 924 may periodically and/or continually query the sensor module 902 for updated environmental information from the first sensor 906, the second sensor 904 and/or and the third sensor 905. If the environment has changed to a sufficient degree, the configuration manager may request a new or updated configuration profile 909. Further, if a change to the content a new configuration profile 909 may be requested.

According to one aspect, the exogenous data or the content itself may dictate a change to the provider presentation settings 910. In such a case, the configuration manager 908 may request an updated configuration profile 909. According to one aspect, one or more configuration profiles 909, or one or more sets of provider presentation settings 910 and presentation instructions 915 may be associated with a given content asset and delivered to the configuration manager 908 as a package or periodically as the content is played back. For example, if a movie includes one or more scenes at night and one or more scenes during the daylight, the configuration profile may include segmented provider presentation settings 910 that may be applied through the presentation instructions 915. The planning module 924 may receive the presentation instructions and appropriately apply the segmented provider presentation settings 910 in time with the scene changes in the movie.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computing system. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

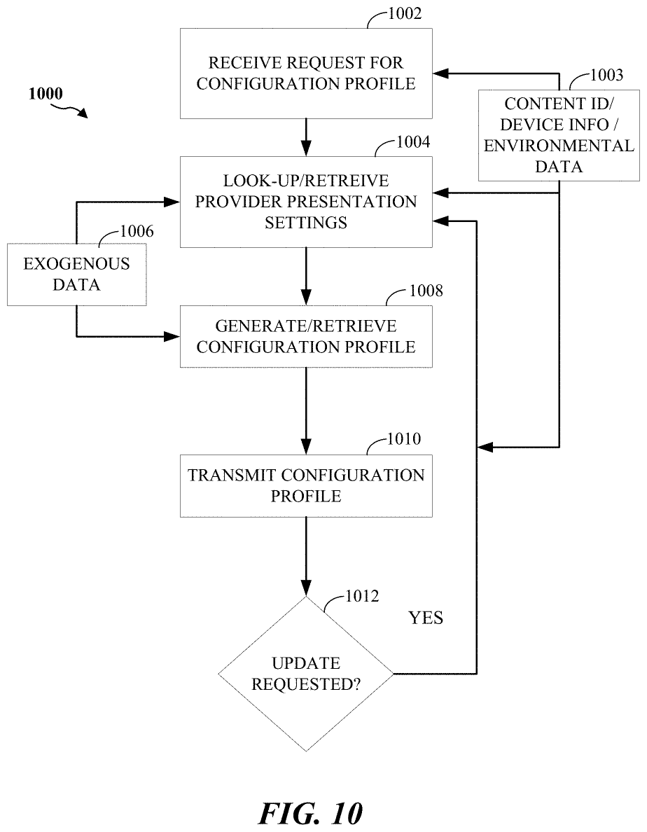

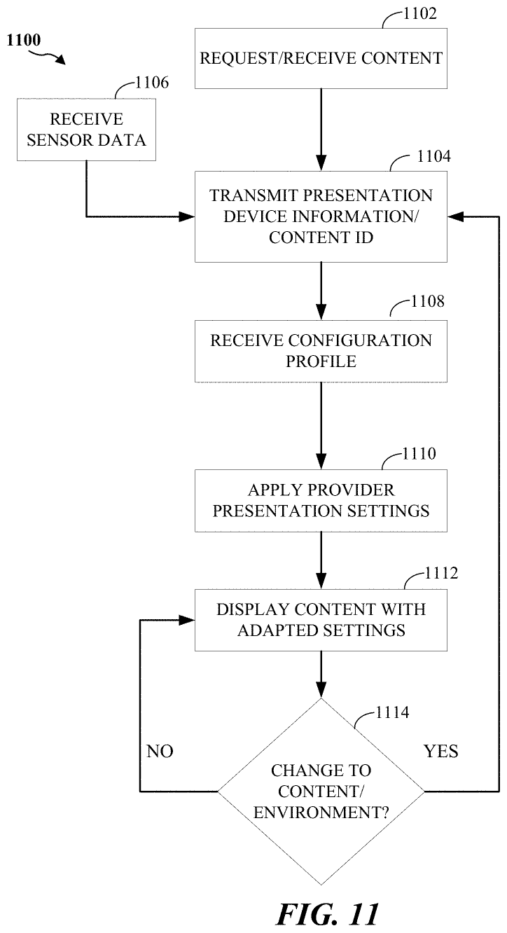

FIG. 10 depicts an exemplary method 1000 of adapting a presentation device display according to one or more aspects of the present disclosure. As shown in block 1002, a service provider may receive a request for a configuration file from a presentation device, as described herein. The request may be transmitted over a network or any other communication protocol as described herein. The service provider may include a content creator, a television broadcast network, a cable television network, a satellite television network, an internet service provider (ISP), a website provider, podcast provider, a VOD service, an OTT service, a content storage and delivery service, a third-party presentation settings provider, or the like, and/or any combination thereof.

The request from the presentation device may include a content identifier, presentation device information and/or environmental data, as shown in block 1003. The content identifier may include any information identifying the content asset to be displayed on the presentation device, including without limitation, title, ID number, or any other identifying information relating to the content asset. Presentation device information may include any identifying or information, specifications, or characteristics of the presentation device, including without limitation, manufacturer, model number, dimensions, display technology, resolution, or the like. Environmental data may include any information relating to the environment in which the presentation device is located, including data obtained from an environmental sensor, as described herein.

The service provider, as shown in block 1004, may look-up or retrieve provider presentation settings based on the content identifier, presentation device information and/or environmental data. As described herein, the service provider may retrieve any number of provider presentation settings appropriate for the identified content, the presentation device and/or any environmental data reported from presentation device. According to one aspect, if the content identifier, presentation device information and/or environmental data is not received from the presentation device in the request for the configuration file, the service provider may request such information from the presentation device. The service provider may additionally base the provider presentation settings on exogenous data, as shown in block 1006 and as described herein. The exogenous data may include data from a content creator detailing who, where, when, and/or how the identified content was created, captured, produced, edited or otherwise obtained and manipulated.

As shown in block 1008, the service provider may generate or assemble a configuration profile, as described herein. The configuration profile may contain the provider presentation settings and presentation instructions for implementing the presentation instructions on the presentation device. The configuration file may further include exogenous data that may be used by the presentation device to further adapt the display settings according to the provider presentation settings. The configuration file may also contain multiple sets of provider presentation settings according to multiple settings profiles, as described herein, and/or changes in the content itself. Further, the service provider may save and store configuration profiles generated, such that repeated requests, requests by the similar or same presentation device's or device types for the same or similar content, need not be regenerated but may be assembled or retrieved.

The service provider may, as shown in block 1010, may transmit the configuration file to the presentation device, as disclosed herein. The configuration profile may be transmitted by any network or communications protocol as described herein. As shown in block 1012, the service provide may receive a request for an updated configuration profile. As described herein, a presentation device may request an updated configuration profile in response to any number or events, including without limitation, a change to a different content asset, a change within the content asset, a change in environmental data, a change to live transmission conditions, or the like. Certain changes, like those in content identification and environmental data, may be included in the updated request.

If an update is received from the presentation device, the system may perform another look-up and retrieval of provider presentation settings based on the updated request, as shown in 1004, to generate, assemble or retrieve an updated configuration profile and transmit the configuration to the profile.

FIG. 11 depicts a method 1100 of adapting the display of a content asset by a presentation device, according to one or more aspects of the present disclosure. A presentation device, as shown in block 1102 may initially request, receive or otherwise obtain a content asset. As described herein, the presentation device may request the content by tuning to a channel, initialize playback of a streaming or on-line program, downloading a content asset, or the like. As shown in block 1104, the presentation device may transmit to a service provider presentation device information, a content identifier and any sensor data received (block 1106) from an environmental sensor integrated or coupled to the presentation device, as disclosed herein. The service provider, as disclosed herein, may receive the presentation device information, content identifier and/or sensor data and generate, assemble, or retrieve a configuration profile accordingly. The service provider may transmit the configuration profile according to any of the communication interfaces and protocols disclosed herein. As shown in block 1108, the presentation device may receive the configuration file from the service provider according to any communications interfaces and protocols disclosed herein.

The configuration profile may include provider presentation settings, presentation instructions, and/or exogenous data relating to the optimal presentation settings as determined by the content creator, service provider or other third-party. As shown in block 1110, the presentation device may apply the provider presentation settings according to the presentation instructions to adjust the parameters of the display settings to match those of the provider presentation settings. As shown in block 1112, the presentation device may display the content according to the adapted provider presentation settings. The presentation device may include an integrated display or may be coupled to a separate display device, to which the presentation device may instruct or otherwise cause the presentation of the content on the display.

As shown in block 1114, the presentation device may periodically or continually monitor the content, environmental data from one or more sensors, or exogenous data to determine of the provider presentation settings need updating. As shown in block 1114, an update to the provider presentation settings may be necessary due to changes of or in the content, the environment in which the content is being presented, or other change in presentation. If such a change is detected, the presentation device may transmit updated device information, content identifier or environmental sensor data to the service provider. The service provider may, upon receiving the updated information, generate, assemble or retrieve an updated configuration profile including updated provider presentation settings and/or exogenous data according to the updated information. If not change is detected, the presentation device may continue to display the content until a change is detected.

What is claimed is:

1. A method for adapting the presentation of content on a presentation device comprising:
receiving from the presentation device presentation device information and a request for a configuration profile associated with a content asset;
retrieving provider presentation settings according to the presentation device information and the content asset;
generating a configuration profile including the provider presentation settings and presentation instructions;
transmitting the configuration profile to the presentation device.

2. The method of claim 1 further comprising:
receiving environmental data from the presentation device; and
wherein retrieving the provider presentation settings is according to the environmental data, the presentation device information, and the content asset.

3. The method of claim 2 further wherein the provider presentation settings comprise one or more setting profiles, each setting profile corresponding to an environmental condition.

4. The method of claim 3 wherein the presentation instructions include choosing a nearest setting profile based on the environmental data.

5. The method of claim 3 wherein the presentation instructions include calculating between two setting profiles based on the environmental data.

6. The method of claim 2 wherein the environmental data is an ambient light level of an environment including the presentation device.

7. The method of claim 2 wherein the environmental data is an air-quality condition.

8. The method of claim 2 wherein the environmental data is an audio signal.

9. The method of claim 1 further comprising:
retrieving exogenous data according to the presentation device information and the content asset; and
wherein retrieving the provider presentation settings is according to the exogenous data, the presentation device information, and the content asset.

10. The method of claim 9 wherein the configuration profile further includes the exogenous data.

11. The method of claim 9 wherein the exogenous data includes at least one of camera-type, camera settings, camera position, camera motion, camera rotation lens type, focus setting, lighting setting, location, time of day, date, weather forecast.

12. The method of claim 1 wherein the presentation device information includes a manufacturer.

13. The method of claim 1 wherein the presentation device information includes a model number.

14. The method of claim 1 wherein the presentation device information includes a display type.

15. The method of claim 14 wherein the display type is one of QLED, OLED, LCD, LED, plasma, microLED, high-definition, ultra-high definition, 4K resolution, 8K resolution.

16. A method for adapting the presentation of content on a presentation device comprising:
receiving from the presentation device presentation device information and a request for a configuration profile associated with a content asset;
receiving environmental data from the presentation display device;
retrieving exogenous data according to the content asset;
retrieving provider presentation settings according to the presentation device information, the environmental data, exogenous data and the content asset;
generating a configuration profile including the provider presentation settings, exogenous data, and presentation instructions;
transmitting the configuration profile to the presentation device.

17. A system for adapting the presentation of content on a presentation device comprising:
a database storing presentation device information and provider presentation settings;
a communications interface; and
a processor configured to:
receive from the presentation device via the communications interface presentation device information and a request for a configuration file associated with a content asset;
retrieve provider presentation settings from the database corresponding to the presentation device information and the content asset;
generate a configuration profile including the provider presentation settings and presentation instructions; and
transmit the configuration profile via the communications interface to the presentation device.

18. A method for adapting the presentation of content on a presentation device comprising:
requesting a content asset;
transmitting presentation device information and a content identifier to the service provider;
receiving a configuration profile including provider presentation settings and presentation instructions, the provider presentation settings and instructions based on the presentation device information and the content identifier; and
executing the presentation instructions to adapt one or more display settings according to the provider presentation settings.

19. The method of claim 18 further comprising:
obtaining environmental data from a sensor coupled to the presentation device;
transmitting the environmental data to the service provider, wherein the provider presentation settings in the configuration profile are further based on the environmental data.

20. The method of claim 19 wherein the sensor is a light sensor.

21. The method of claim 19 wherein the sensor is an air-quality sensor.

22. The method of claim 19 wherein the sensor is a microphone.

23. The method of claim 19 wherein the sensor is thermal sensor.

24. The method of claim 19 wherein the sensor is a motion sensor.

25. The method of claim 19 wherein the configuration profile further includes exogenous data, the provider presentation settings further based on the exogenous data.

26. The method of claim 26 wherein the exogenous data includes at least one of camera-type, camera settings, camera position, camera motion, camera rotation lens type, focus setting, lighting setting, location, time of day, date, weather forecast.

27. The method of claim 18 wherein the presentation device information includes a model number.

28. The method of claim 18 wherein the presentation device information includes a display type.

29. The method of claim 28 wherein the display type is one of QLED, OLED, LCD, LED, plasma, microLED, high-definition, ultra-high definition, 4K resolution, 8K resolution.

30. A system for adapting the presentation of content including:
a presentation device,
one or more environmental sensors in communication with the presentation device;
a configuration manager in communication with the presentation device the and the one or more environmental sensors;
a processor in communication with the presentation device, the one or more environmental sensors and the configuration manager, the processor configured to:
request a content asset;
receive a request for presentation device information from a service provider;
transmit presentation device information to the service provider;
receive a configuration profile including provider presentation settings and presentation instructions, the provider presentation settings adapted according to the presentation device information; and
decode the configuration profile to adapt one or more display settings of the presentation device according to the provider presentation settings and presentation instructions.

31. A method for adapting the presentation of content on a presentation device comprising:
requesting a content asset;
obtaining environmental data from a sensor coupled to the presentation device;
transmitting presentation device information, the environmental data, and a content identifier to the service provider;
receiving a configuration profile including provider presentation settings and presentation instructions, the provider presentation settings and instructions based on the presentation device information, environmental data, exogenous and the content identifier; and
executing the presentation instructions to adapt one or more display settings according to the provider presentation settings.
